(19) United States
(12) Patent Application Publication
(10) Pub. No.: US 2012/0153782 A1
(43) Pub. Date: Jun. 21, 2012

(54) Modular outdoor fireplace and kitchen structure kit

(76) Inventor: Darcy A. Fraser, Calgary (CA)

(21) Appl. No.: 12/928,576

(22) Filed: Dec. 15, 2010

(51) Int. Cl. A47B 87/00; A47B 88/04; B23P 11/00; A47B 96/00

(52) U.S. Cl. 312/109; 312/107; 29/428

(57) ABSTRACT

The invention relates to the construction of outdoor living structures, notably outdoor kitchens and fireplaces designed for outdoor entertaining and food preparation on outdoor patios, raised decks, terraces and other such areas. The invention is designed to be simplistic in nature such that it is capable of being assembled by the average do-it-yourself homeowner or likewise by trades-people and the use of skilled labour with minimal tools. The invention incorporates the fabrication of a top and bottom panel, or cap composed of rust and corrosion-resistant materials such as galvanized or possibly stainless steel in addition to the fabrication of internal dedicated structural members of a unique design allowing for a minimal number of components to be required for the completion of such a kit. All kits shall be designed to be of similar size with identical height and depth dimensions so as to allow the modules to be combined and arranged in an infinite number of combinations and satisfy the unique needs of each individual undertaking such an endeavour.

### RELATED APPLICATIONS

This application is a continuation of U.S. provisional patent application 61/283,982 filed with the United States Patent & Trademark Office on Dec. 28, 2009, and re-submitted as per the instructions given in confirmation letter No. 2500 of Jan. 6, 2011.

### BACKGROUND

Current living trends have created a new marketplace designed around the creation of extended living spaces in an outdoor environment which duplicate, in whole or in part, an indoor living environment. Although portable devices such as cart-mounted barbecue grills and fire pits are readily available, a growing number of people are constructing permanent structures to house both cooking and decorative heating appliances. Outdoor kitchens (also generically referred to as barbecue islands) in particular have an inherent appeal by providing a functional environment which allows smoke, heat and other by-products of the cooking process to be restricted to an outdoor environment. Food preparation, cooking, beverage storage and other such tasks may also be performed through the use of such a purpose-built structure.

Generally accepted construction methodologies for such structures have included many varieties which have been proven to be limited in scope due to a broad number of reasons ranging from weight of materials, complexity of design, time constraints and overall cost. Typical outdoor kitchen and fireplace structure construction projects are tremendously complex and limited in application due to weight and time limitations. Additionally, almost all projects of this nature are referred to as “custom” with no two being the same in scope, cost, materials, design and complexity of construction. Most projects take construction time in excess of one to two weeks just for the structural elements prior to finishing with appropriate materials such as counter tops, stucco and/or masonry treatments.

Therefore it is felt that there is a need for such a construction methodology that allows for the construction of outdoor kitchens and fireplaces in virtually any environment with virtually no limitations based on overall size, time of installation, installation complexity, cost and weight restrictions. There is a need for a kit form of modular components which can be arranged in a myriad of combinations, constructed in most standard outdoor living spaces in a short span of time and capable of being put together by the average homeowner as well as skilled trades-people. Such a standardized system shall allow construction to proceed anywhere in a timely fashion and in doing so provide cost savings for all levels of end user. As a “knock-down” kit it shall also be capable of being stored in reasonable quantities in a retail setting through efficiency of packaging dimensions and light weight.

### SPECIFICATIONS OF THE INVENTION

The invention is a system of construction intended to create the framework for an outdoor lifestyle structure(s) through the assembly of a plurality of modular outdoor kitchen and fireplace modules in such a manner as to allow an end user to create a functional outdoor living environment in a stronger, faster and more cost effective manner than previously available through conventional methods. Modules are designed to be aligned in a linear fashion and/or angular fashion and be permanently fastened together prior to the application of exterior weather resistant finishing materials. For purposes here, weather resistant shall heretofore refer to an inherent resistance to wind, moisture (frozen or liquid form), extreme temperatures both hot and cold, and exposure to sunlight over a long period of time without severe degradation. Once assembled into its completed form the structure is intended to be covered in such materials in such a manner as to have the appearance that the structure has been constructed from the weather resistant materials in its entirety. The invention assumes that modules not as yet determined may evolve using the same methodology being claimed herein. All modules would be assembled and attached to each other through the use of self-drilling, truss-head screws to be included in sufficient quantity with each kit so as to allow for assembly and connection to other adjacent modules.

The invention also includes the intention that certain unique modules shall exist such that a single such module shall be capable of creating the framework for an outdoor kitchen or outdoor fireplace independently with no requirement that it be attached to any other such modules in order to be functional. These specific modules are created in such a manner as to be adaptable to accept a plurality of pre-fabricated fireplaces or cooking grills and burners from most manufacturing organizations that produce such equipment. Although capable of being independent modules they shall be fully capable of being combined with other modules to create a larger and more varied arrangement due to a common dimensional configuration aligned with the other modules intended to be mated to each other as noted in section 0006. Once assembled into its completed form the structure is intended to be covered in such materials in such a manner as to have the appearance that the structure has been constructed from the weather resistant materials in its entirety. The invention assumes that modules not as yet determined may evolve using the same methodology being claimed herein. All modules would be assembled and attached to each other through the use of self-drilling, truss-head screws to be included in sufficient quantity with each kit so as to allow for assembly and connection to other adjacent modules

The invention also includes an outdoor cabinet module that can be assembled and utilized independent of the requirement that it be fastened to any other modules. Once assembled into its completed form the structure is intended to be covered in such materials in such a manner as to have the appearance that the structure has been constructed from the weather resistant materials in its entirety. The invention assumes that modules not as yet determined may evolve using the same methodology being claimed herein. All modules would be assembled and attached to each other through the use of self-drilling, truss-head screws to be included in sufficient quantity with each kit so as to allow for assembly and connection to other adjacent modules

The invention is further specified to be fabricated entirely of non-combustible materials such that any extraneous flame arising from the operation of the attached cooking and/or decorative heating appliances such as fireplaces shall not be capable of igniting the structure under any circumstances. Each structural element shall be composed in its entirety of structural steel treated in such a manner as to not only be impervious to flame but to also be resistant to rust by being composed of either galvanized or stainless steel. All weather resistant coverings applied to the structure shall be composed entirely of non-combustible materials. All modules would be assembled and attached to each other through the use of self-drilling, truss-head screws to be included in sufficient quantity with each kit so as to allow for assembly and connection to other adjacent modules

The invention is further capable of being transported in kit form to the final point of assembly in lightweight biodegradable cardboard packaging which can be easily carried or transported in standard personal vehicles without the requirement of having such equipment available such as a forklift, crane, lift, lift-gate, hydraulic lifts or any other such device as would be required for items of excessive size and weight. The invention shall be packaged into individual boxes in sizes that permit easy handling as stock keeping units and inventoried in large quantities while utilizing a relatively small amount of space in such a warehouse facility as would be common in home improvement retail businesses. All modules would be assembled and attached to each other through the use of self-drilling, truss-head screws to be included in sufficient quantity with each kit so as to allow for assembly and connection to other adjacent modules

The invention also includes unique individual structural components which, when combined in multiples with other different structural components, comprise a module for an outdoor kitchen and/or fireplace. Each module shall consist of a unique top (hereafter referred to as the cap), a unique bottom (hereafter referred to as a pan) and a plurality of a unique vertical and horizontally combined structural component (hereafter referred to as a strut or struts) which shall be common to all outdoor kitchen modules. Unique struts shall exist for outdoor fireplace modules in such dimensions as to make them capable of being mated with outdoor kitchen components so as to create a consistent overall dimension by way of a standardized horizontal dimension should it be desirable to combine both an outdoor kitchen and outdoor fireplace structure. All modules would be assembled and attached to each other through the use of self-drilling, truss-head screws to be included in sufficient quantity with each kit so as to allow for assembly and connection to other adjacent modules

### PRIOR ART

Previous variations on modular construction have been ascribed to the following applications:
DiMatteo et. al. U.S. 2007/0204844 A1 (adjustable structure)
Thompson U.S. 2004/0065313 A1 (modular cabinetry) now file Pat No. D 475,552

These variations have been based on a “stick-frame” approach to construction or the fabrication of factory built completed modules designed to be shipped in assembled form. The structures described in the following invention are substantially easier to assemble than the stick frame approach described by DiMatteo et. al. and tremendously lighter in weight and easier to manipulate than the pre-fabricated modules proposed by Thompson.

### BRIEF DESCRIPTION OF THE DRAWINGS (APPENDIX)

FIG. 1. A perspective view of an example of possible plurality of modules combined to create an outdoor kitchen and fireplace structure.

FIG. 2. A perspective view, with dimensions, of the standardized “strut” that would be common to all outdoor kitchen modules

FIG. 3. A perspective view of a 72″ high fireplace enclosure module

FIG. 4. A perspective view of a 48″ high fireplace enclosure module

FIG. 5. An exploded view of the same 48″ high fireplace enclosure module as noted in #3

FIG. 6. An exploded view of a possible optional ornamental top cap for the fireplace enclosure modules

FIG. 7. A perspective view of a 72″ long outdoor kitchen module intended to support and enclose a dedicated built-in cooking grill

FIG. 8. An exploded view of the same 72″ long outdoor kitchen module for use with a dedicated built-in cooking grill as noted in #6

FIG. 9. A perspective view of a module intended to be either a counter top extension or capable of housing a dedicated side burner appliance

FIG. 10. An exploded view of the same side burner cabinet module as noted in #8.

FIG. 11. A perspective view of a possible 36″ long outdoor cabinet module

FIG. 12. An exploded view of the same 36″ long outdoor cabinet module as noted in #10

FIG. 13. A perspective view of a possible wok burner enclosure module

FIG. 14. An exploded view of the same wok burner module as noted in #12

FIG. 15. A perspective view of a 45 degree extension module

FIG. 16. A perspective view of a 90 degree extension module

FIG. 17. An exploded view of the same 90 degree extension module as noted in #15

FIG. 18. A perspective view of a 90 degree full cabinet enclosure module

FIG. 19. An exploded view of the same 90 degree cabinet module as noted in #17

FIG. 20. A perspective view of possible backsplash/bar module

### DETAILED DESCRIPTION WITH REFERENCE TO DRAWINGS IN APPENDIX

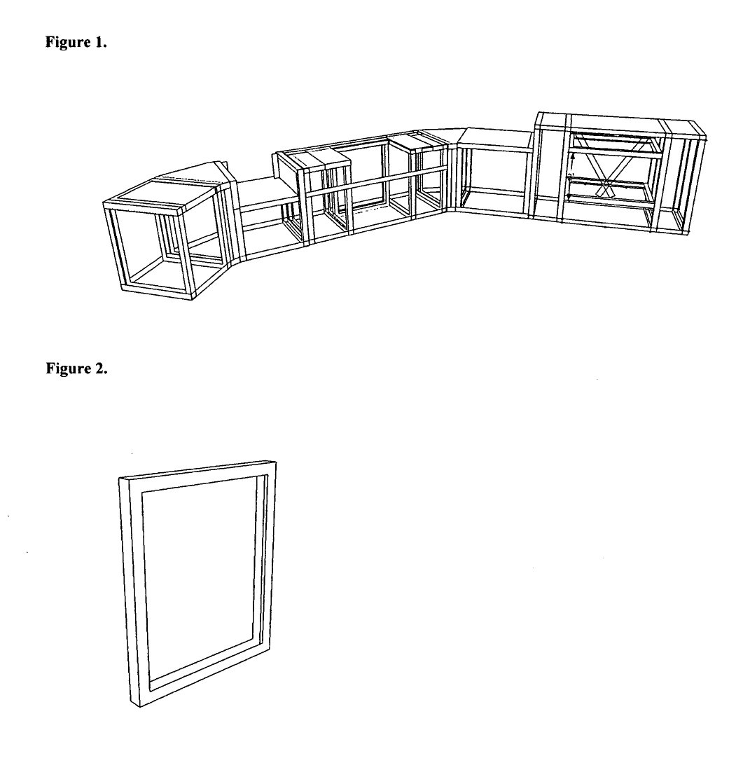

FIG. 1. Shows an example of how various different modules as described here might be combined to create an outdoor kitchen and fireplace structure ready to be covered and finished in non-combustible weather resistant materials as described above. Through the use of a consistent horizontal and vertical dimension, all modules are able to be aligned with all other modules to create a linear and/or angular arrangement, or a combination of both approaches as shown in the figure. The image shows a configuration capable of supporting a built-in cooking grill, wok burner, side burner and outdoor fireplace. Cabinet space below shall be capable of supporting various access doors, drawer assemblies and possible appliances such as warming drawers and refrigeration units. This combination uses a 72″ grill module (image #6), a side burner module (image #8), a wok burner module (image #12), two 45 degree extension modules (image #14) and a 48″ high outdoor fireplace module (image #3). Due to the interchangeable nature of the system, this is merely one example of the infinite number of possible combinations and the system is not limited to the combination shown here.

FIG. 2. Shows the standardized “strut” that would be common to all outdoor kitchen modules. A similar strut would be fabricated in different height dimensions to be utilized with the different fireplace enclosure modules but with the same depth dimension so as to allow the fireplaces to be used both independently and in combination with the outdoor kitchen modules, as shown in image #1.

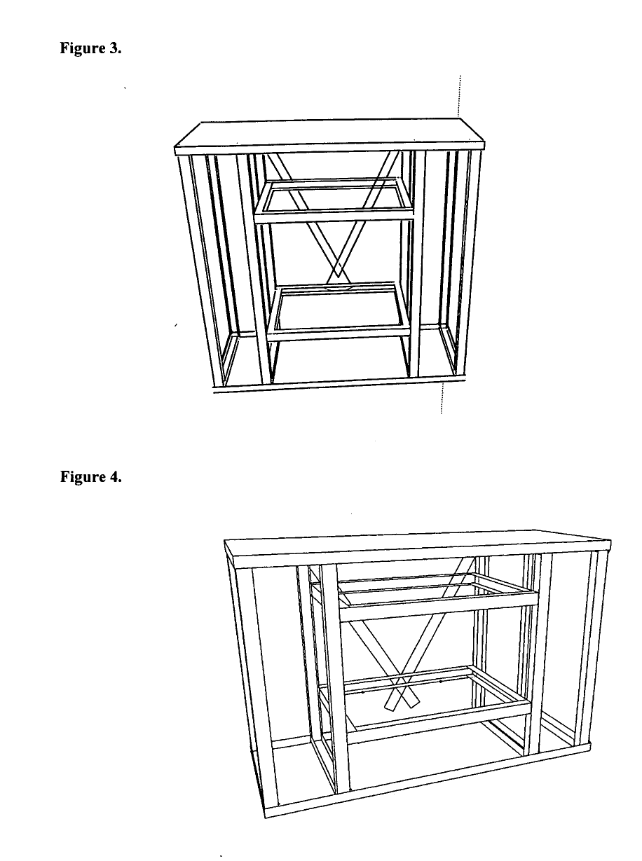

FIG. 3. Shows a detailed perspective image of the completed 72″ high outdoor fireplace module. Such a module shall be capable of housing nearly all models of outdoor gas and wood burning fireplace appliances currently available from almost all manufacturers currently providing such appliances. Once assembled the module is capable of being used independently or in combination with other modules.

FIG. 4. Shows a detailed perspective image of the completed 48″ high outdoor fireplace module. Such a module shall be capable of housing nearly all models of outdoor gas and wood burning fireplace appliances currently available from almost all manufacturers currently providing such appliances. Once assembled the module is capable of being used independently or in combination with other modules.

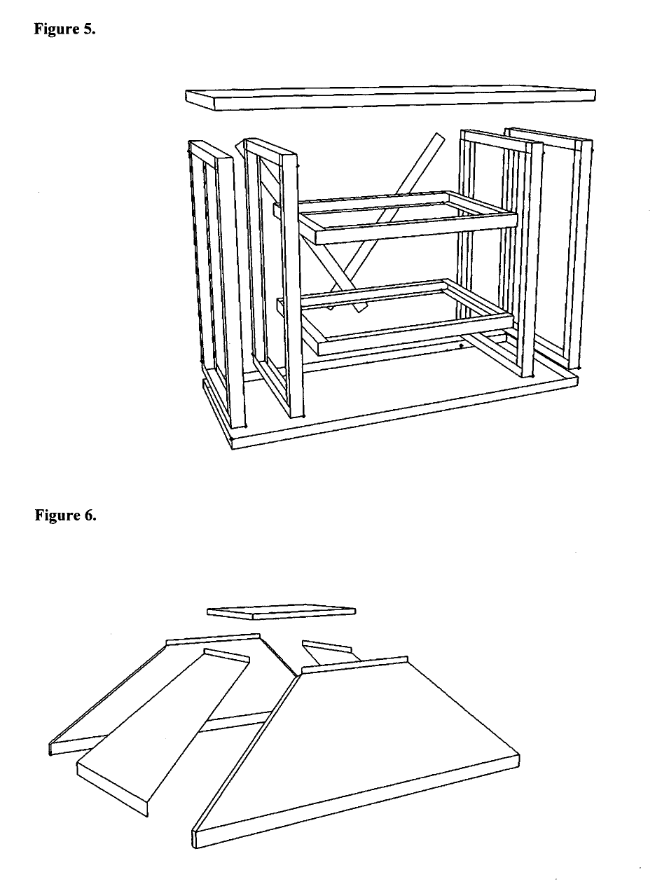

FIG. 5. Shows an exploded view of the same 48″ high fireplace enclosure described previously. The standardized “struts” are utilized as a system of vertical support and are fastened to the top “cap” and bottom “pan” so as to complete an outer framework for the remainder of the structure. Two different additional struts are shown in a horizontal alignment in order to support the weight of the appliance to be installed, however the height at which they are placed shall be determined by the desires of the owner and by local and national building and fire codes for the appliance to be installed. A final two straps are to be affixed to the rear of the structure to provide further stability and support for the appliance. Once assembled the module is capable of being used independently or in combination with other modules.

FIG. 6. Shows an exploded view of a possible ornamental top cap to be applied to a completed fireplace enclosure structure purely for aesthetic purposes and to provide a means of lateral support for a chimney structure in the event that the appliance installed into the enclosure requires one. Such an item could be fabricated from a variety of metals such as stainless steel, copper, steel and aluminum with colours applied as desired.

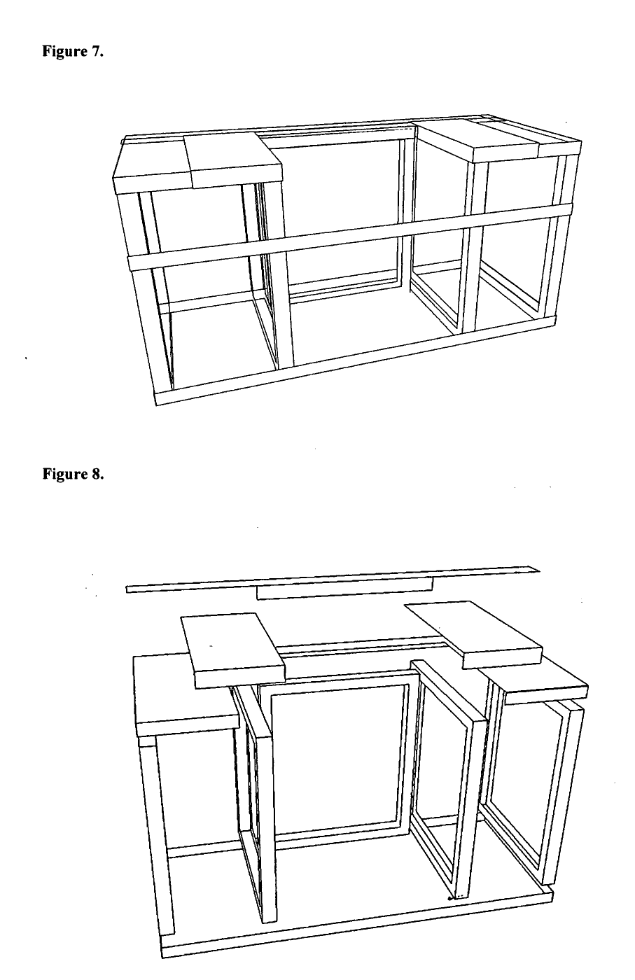

FIG. 7. Shows a perspective image of a 72″ grill enclosure module. This module would be capable of accepting and supporting built-in cooking modules ranging in width from 30″ to 43″ across with a depth front to back ranging from 20″ to 26″ through the use of adjustable collars fit to the top “cap”, details of which shall be seen in the following image.

FIG. 8. Shows an exploded view of the same 72″ grill module described previously. The module uses two of a standardized strut as described previously to provide vertical and horizontal support and stability by fastening to the top “cap” and bottom “pan” to provide an outer framework for the remainder of the structure. Two inner struts are fastened in position as determined by the width of the appliance to be installed in the enclosure so as to provide support below said appliance. Placement of the central strut in an orientation perpendicular to the other four is determined by the depth dimension of the appliance to be installed in the enclosure. The top collars are then applied to close the top surface in advance of the application of a non-combustible weather resistant counter top surface as denoted previously. Once assembled the module is capable of being used independently or in combination with other modules.

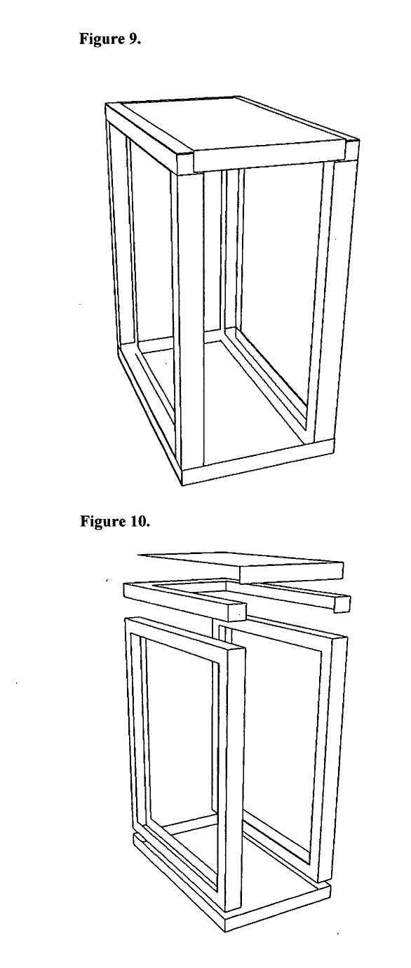

FIG. 9. Shows a perspective view of a side burner cabinet module also capable of being used solely for the installation of a counter top surface. Capable of being used independently the module would generally be affixed to an adjoining module on either or both sides.

FIG. 10. Shows an exploded view of the side burner extension module as described above. The enclosure utilizes the same methodology as described for the grill enclosure module. Two struts are affixed to a top “cap” and a bottom “pan” to create a framework that is either considered to be complete or can be finished through the installation of an included top cover fastened to the top “cap” to cover the opening and provide support for an intended counter top.

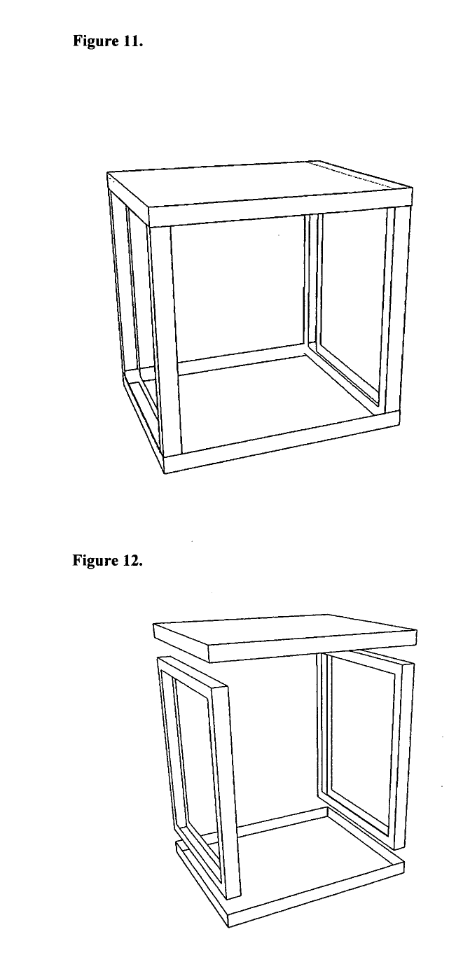

FIG. 11. Shows a perspective view of a possible 30″-36″ wide extension module designed to provide counter top surface or house such items as a pre-fabricated cocktail centre or double wide side burner appliance.

FIG. 12. Shows an exploded view of the previously described 30″-36″ wide extension module. Assembly would be completed through the affixing of two struts to a top “cap” and bottom “pan” to provide a framework for the module. Though not shown here, a possible design consideration is to have the module equipped in the same manner as the smaller side burner extension module (image #8) to allow for a variety of possible appliance installations.

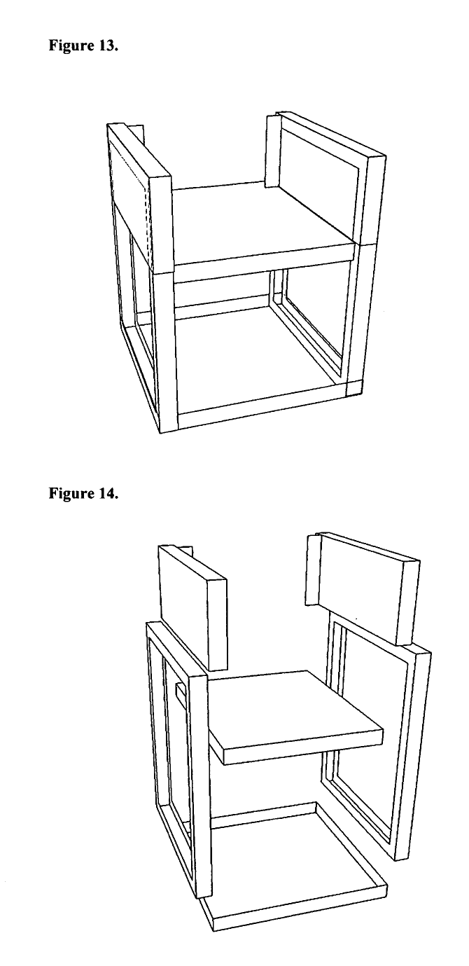

FIG. 13. Shows an experimental wok burner module designed to house and support a large wok burner appliance at a much lower height than the other previously described modules due to the possibility of it being used for excessively large and/or heavy cooking utensils, stock pots and woks.

FIG. 14. Shows an exploded view of the aforementioned wok burner enclosure. The enclosure would be assembled through the use of two struts fastened to a mid-height “cap” and a bottom “pan” in addition to two side shields intended to aid in the containment of hot liquids such as oil and water. Once assembled the enclosure could function independently or be used in combination with other modules to create an outdoor kitchen.

FIG. 15. Shows a perspective view of a 45 degree corner extension module. Such a module would be utilized to accommodate the creation of an design orientation where required for structural, aesthetic or logistical requirements.

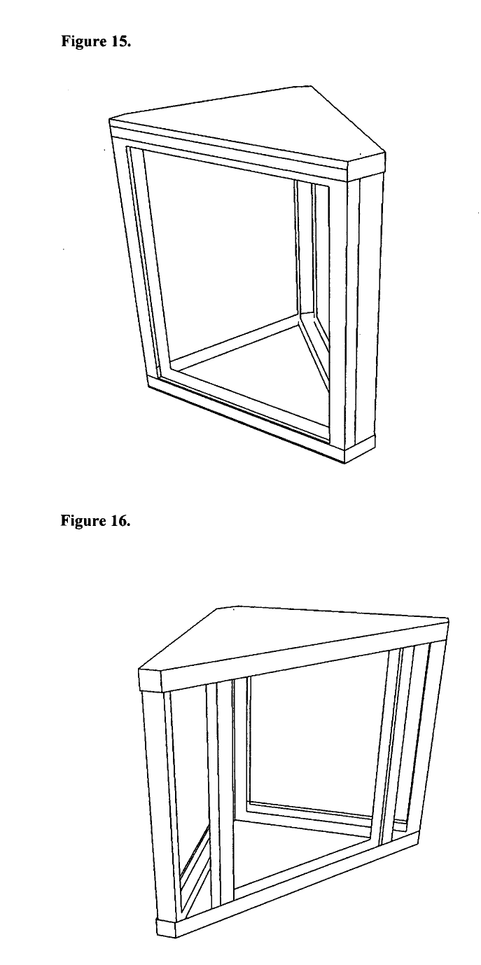

FIG. 16. Shows a perspective view of a 90 degree corner extension module. Such a module would be utilized to accommodate the creation of an design orientation where required for structural, aesthetic or logistical requirements.

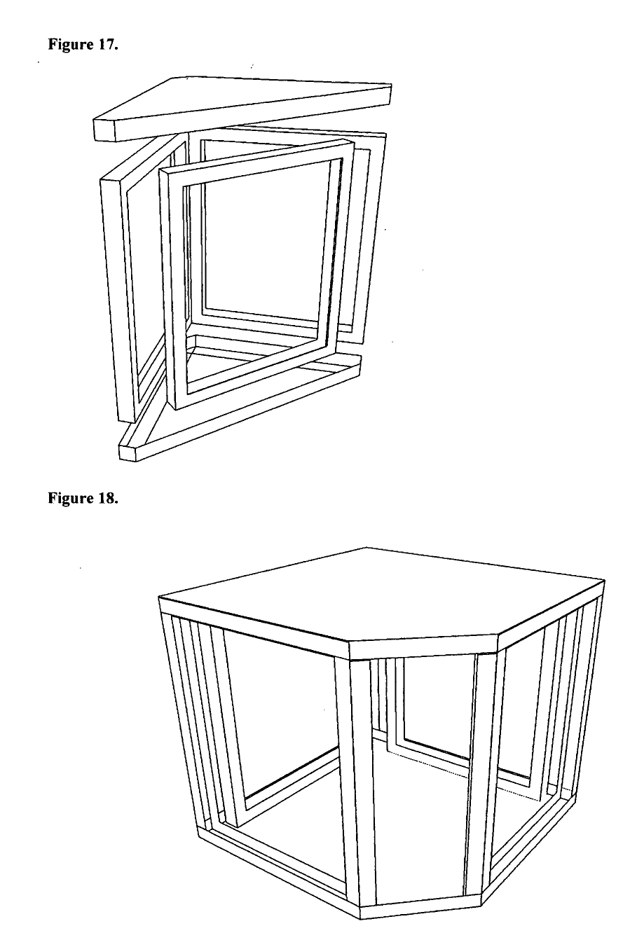

FIG. 17. Shows an exploded view of the 90 degree corner extension module described previously. The assembly is completed through the use of three of the same struts used on all of the outdoor kitchen modules, each aligned with an outer edge of the top “cap” and the bottom “pan”. Once assembled the module would be affixed to adjoining modules on either or both sides.

FIG. 18. Shows a perspective view of a 90 degree full cabinet enclosure module. This module shall provide the possibility of creating a 90 degree angle both along the font and rear surfaces of the final combined series of modules once affixed on either or both sides.

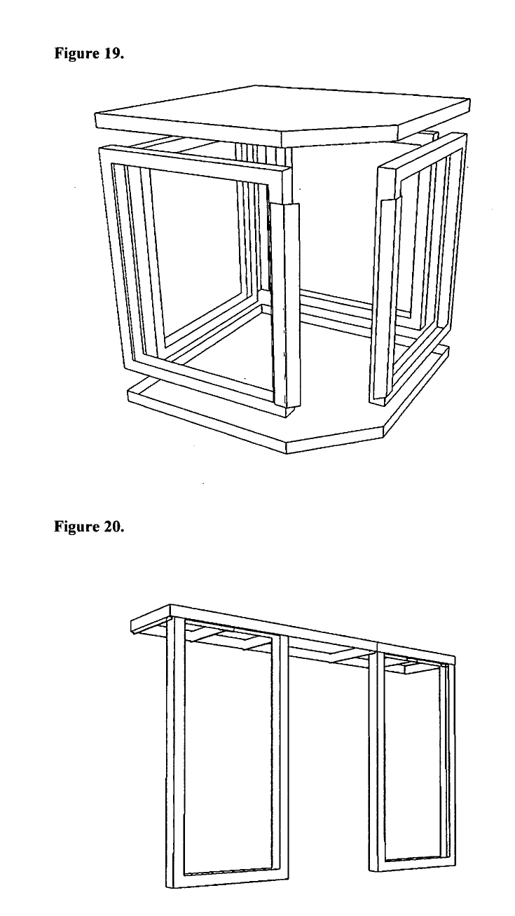

FIG. 19. Shows an exploded view of the 90 degree full cabinet enclosure module as described previously. The enclosure kit would be assembled by affixing each of the four included struts in alignment with the outer edges of the top “cap” and bottom “pan” to provide the basic framework for the enclosure. Further corner straps would be applied, as shown, to permit proper fastening of non-combustible weather resistant surface and finish materials.

FIG. 20. Shows a perspective view of a backsplash assembly intended to be affixed to the rear of a 72″ grill module as described previously. The assembly is composed of a heightened variation of the standard internal strut aligned parallel to the rear edge of the enclosure. This variation demonstrates a possible eating or serving bar surface on the top edge intended to support a basic counter top surface. The intent would be for the backsplash assembly to be fastened prior to the covering of the module with the cement board surface prescribed in this application.

What is claimed:

1. A modular outdoor kitchen and/or fireplace structure comprising:
A system of modular construction kits intended to be arranged and combined in a manner such as is desired by the end user that ultimately results in the creation of a functional outdoor kitchen framework while being extremely lightweight, durable, exceedingly strong and able to be assembled by nearly any able-bodied adult with minimal tools
A system of modular construction kits intended to provide a single complete and functional outdoor fireplace or kitchen framework without the requirement that it be attached to or combined with any other such modules in order to be considered to be complete.
wherein the completed structure is capable of accepting a varied assortment of manufactured cooking and decorative heating appliances as would be utilized in the creation of such an outdoor environment, and where the framework is ready to be covered in such non-combustible weather resistant building materials so as to imply that the entire structure is in fact composed entirely of said building materials.

2. A modular outdoor kitchen and/or fireplace structure according to claim #1 wherein it can be comprised of a minimum of two modules which can be arranged in two different arrangements to create different outdoor kitchens and/or fireplaces

3. A modular outdoor kitchen and/or fireplace structure according to claim #1 wherein each module can be connected to any other module regardless of which side is aligned with which, including the possibility that each module can be facing a direction opposite to the one immediately adjacent to it.

4. A modular outdoor kitchen and/or fireplace structure according to claim #1 wherein standard cabinet modules may be stacked one upon the other to a maximum of two in combination, with there being no requirement that they face the same direction.

5. A modular outdoor kitchen and/or fireplace structure according to claim #1 wherein doors or drawer units may be housed within the structure to provide access and storage for such items as is desired by the owner.

6. A modular outdoor kitchen and/or fireplace structure according to claim #1 wherein different modules may be combined in an infinite number of possible combinations as desired by the owner.

7. A modular outdoor kitchen and/or fireplace structure according to claim #1 wherein the same module may be utilized in multiple quantities as desired by the owner.

8. A modular outdoor kitchen and/or fireplace structure according to claim #1 wherein at least, but not limited to, one module is capable of housing a dedicated built-in cooking grill.

9. A modular outdoor kitchen and/or fireplace structure according to claim #1 wherein at least, but not limited to, one module is capable of housing a dedicated built-in side burner.

10. A modular outdoor kitchen and/or fireplace structure according to claim #1 wherein at least, but not limited to, one module is capable of housing a dedicated built-in wok burner.

11. A modular outdoor kitchen and/or fireplace structure according to claim #1 wherein at least, but not limited to, one module is capable of housing a dedicated built-in cocktail centre.

12. A modular outdoor kitchen and/or fireplace structure according to claim #1 wherein at least, but not limited to, one module may be used to create a 45 degree offset angle for the completed outdoor kitchen.

13. A modular outdoor kitchen and/or fireplace structure according to claim #1 wherein at least, but not limited to, one module may be used to create a 90 degree offset angle for the completed outdoor kitchen while providing a 45 degree offset angle across the rear portion of the completed structure.

14. A modular outdoor kitchen and/or fireplace structure according to claim #1 wherein a module may be used to create a 90 degree offset angle for the completed outdoor kitchen while providing a 90 degree angle across the rear portion of the completed structure.

15. A modular outdoor kitchen and/or fireplace structure according to claim #1 wherein a module exists that shall provide for the installation of an outdoor gas burning fireplace with a finished height no greater than 48″.

16. A modular outdoor kitchen and/or fireplace structure according to claim #1 wherein a module exists that shall provide for the installation of an outdoor gas burning fireplace with a finished height no greater than 72″.

17. A modular outdoor kitchen and/or fireplace structure according to claim #1 wherein a single fireplace module may be used independently of all other modules.

18. A modular outdoor kitchen and/or fireplace structure according to claim #1 wherein a fireplace module may be used in conjunction with any combination of other modules on either or both sides.

19. A modular outdoor kitchen and/or fireplace structure according to claim #1 wherein a fireplace structure may be used in conjunction with other modules in a manner where it faces a direction opposite to at least one of the adjacent modules.

20. A modular outdoor kitchen and/or fireplace structure according to claim #1 wherein a fireplace module may be used in conjunction with other modules in an orientation such that it faces the same direction as the adjacent module(s).

21. A modular outdoor kitchen and/or fireplace structure according to claim #1 wherein an outdoor kitchen may be created through the use of at least one module dedicated to enclosing a dedicated outdoor cooking appliance.

22. A modular method for constructing an outdoor fireplace and/or kitchen structure which comprises:
a. A standardized support structure common to all structures of the same type fabricated from stainless or galvanized steel
b. A top cap fabricated from stainless or galvanized steel to provide weather resistance and structural strength and support
c. A bottom pan fabricated from stainless or galvanized steel to provide weather resistance and structural strength and support
d. A series of adjustable collars and top panels so as to provide a universal adaptability to accept a broad variety of pre-fabricated cooking appliances for said outdoor kitchen(s)
e. A series of arbitrarily placed horizontal struts to allow for the installation of a broad variety of pre-fabricated fireplaces in said outdoor fireplace structure(s)

23. A modular method for constructing an outdoor fireplace and/or kitchen structure according to claim 22 which can be provided in a “flat-packed” method for shipment such that:
a. Each module may be carried in unassembled for to a job site by no more than two people based due to the lightweight nature of each kit
b. Each module may be carried in unassembled for to a job site by no more than two people based due to the modest size of the packaging for each kit
c. Each module shall be supplied in no more than two packages, each package meeting the requirements of 23 a and 23 b above.

24. A modular method for constructing an outdoor fireplace and/or kitchen structure according to claim 22 which can:
a. Be combined in an infinite number of configurations
b. Allow individual modules to be moved around each other once assembled in order to aid in the determination of a final configuration
c. Be permanently assembled through the attachment of adjacent modules to create a framework for the final structure
d. Accept non-combustible covering materials to all surfaces to provide a suitable basis for the application of non-combustible finish materials such as stone, tile, concrete, stucco
e. Accept non-combustible covering materials to all surfaces to provide a suitable basis for the application of combustible finish materials such as wood where such applications are permitted by the manufacturer(s) of the appliances to be installed in adherence to local and national building and fire codes and to the specifications of the manufacturers of said appliances.
